(19) United States
(12) Patent Application Publication
(10) Pub. No.: US 2016/0282520 A1
(43) Pub. Date: Sep. 29, 2016

(54) ORGANIC-INORGANIC HYBRID MATERIAL, OPTICAL THIN LAYER OF THIS MATERIAL, OPTICAL MATERIAL COMPRISING SAME, AND PROCESS FOR PRODUCING SAME

(71) Applicant: COMMISSARIAT A L'ENERGIE ATOMIQUE ET AUX ENERGIES ALTERNATIVES, Paris (FR)

(72) Inventors: Nicolas Marchet, Joue Les Tours (FR); Philippe Belleville, Tours (FR); Philippe Prene, Artannes Sur Indre (FR)

(21) Appl. No.: 15/179,549

(22) Filed: Jun. 10, 2016

Related U.S. Application Data
(62) Division of application No. 12/865,839, filed on Aug. 26, 2010.

(30) Foreign Application Priority Data
Feb. 5, 2008 (FR) 08/50708

(51) Int. Cl. G02B 1/111; C09D 5/00; C09D 127/16; C09D 7/12; G02B 1/10; G02B 1/04

(52) U.S. Cl. CPC G02B 1/111; G02B 1/10; G02B 1/04; C09D 127/16; C09D 7/1225; C09D 5/006

(57) ABSTRACT

Organic-inorganic composite material comprising:
colloidal particles of at least one inorganic compound chosen from metal or metalloid oxides and oxyhydroxides, prepared by means of a process of hydrolysis-condensation in a protic or polar solvent, said particles having been surface-functionalised by reaction with an organic compound;
and an organic or inorganic polymer.

Process for preparing this composite material and optical material comprising a layer of this composite material.

### TECHNICAL FIELD

The invention relates to an organic-inorganic hybrid, composite material comprising particles of an inorganic compound which are surface-functionalised with an organic compound, and an organic polymer.

This hybrid material can in particular be placed (shaped) in the form of an optical thin layer or else of an absorbent coloured layer.

For the purpose of the invention, the term “optical thin layer” is intended to mean generally a layer which makes it possible to produce coatings which are transparent, preferably in a range of wavelengths between ultraviolet and near infrared, this range of wavelengths including the visible spectrum.

The term “transparent material, coating” is intended to mean a material, coating through which light rays having wavelengths that lie in the spectral range of interest, which is, for example, the range defined above, can pass.

Use is also made of the terms “films, thin layers of “optical quality””, which mean that these films, which are transparent, do not exhibit any scattering and/or absorption in the spectral range of interest.

The invention also relates to an optical material comprising said layer or said organic-inorganic hybrid material.

Finally, the invention relates to a process for preparing this material and these thin layers.

The technical field of the invention can, in general, be defined as that of the preparation of inorganic-organic hybrid or composite materials.

The expression “inorganic-organic hybrid or composite material” is intended to mean a material comprising at least one component of organic nature, such as an organic polymer, and at least one inorganic component, such as inorganic particles of metals or of metalloids, or of metal or metalloid compounds, such as metal or metalloid oxides.

### BACKGROUND ART

Several processes for producing inorganic-organic hybrid solutions or films have already been described.

Thus, document [1] describes a composite material with a high refractive index, the process for producing it, and also optically active materials, in particular antireflective materials and reflective materials produced from this composite material.

More specifically, in this document, a suspension of metal oxide colloids dispersed in an aliphatic alcohol is prepared; this colloidal suspension is mixed with a polyvinyl polymer that is soluble in a solvent containing an alcohol; the mixture or sol obtained is deposited on a support so as to form a uniform layer, and this layer is crosslinked by means of a treatment with ultraviolet rays.

In this document, the colloidal particles are not surface-functionalised by reaction with an organic compound, but are simply coated in a polyvinyl polymer.

The process described by this document has a very limited application since it concerns only polymers that are soluble in solvents containing essentially water and/or alcohols.

This document does not describe a step of surface-functionalising the particles with an organic compound, nor a step of exchange of a protic solvent with an apolar aprotic solvent so as to give a suspension of particles which are surface-functionalised with the organic compound, in the aprotic organic solvent.

The solvents used in this document are always polar solvents and no compatibilisation problem arises.

Finally, an optional step of solubilisation of an organic polymer in an aprotic apolar organic solvent is not described either, since the polymers are soluble in water and alcohols.

Document [2] describes stabilised dispersions in a continuous liquid phase of inorganic nanoparticles such as nanoparticles of silica or of metal oxides, surface-modified with silanes, organic acids, organic bases and alcohols.

The continuous liquid phase is chosen from water and organic liquids, including polymers.

In the examples, a suspension, in toluene, of silica nanoparticles surface-modified with isooctylsilane, or else a suspension of colloidal silica surface-modified with a silane, in ultrapure water, is prepared.

Hybrid solutions comprising inorganic nanoparticles in a solution of organic or inorganic polymer, a fortiori in a solution of organic polymer in an apolar, aprotic, organic solvent are not described in this document, which also does not mention the preparation of real inorganic-organic hybrid materials comprising an organic polymer.

In addition, in documents [1] and [2], the solvent used, such as water, is essentially polar, protic.

However, the use of certain organic polymers is incompatible with the presence of water when it is desired to prepare thin layers of optical quality. Water is in fact a non-solvent for many organic polymers. The presence of an organic polymer in a solution comprising water or another protic solvent leads to the appearance of a non-solubilised polymer fraction. A poor optical quality, which results in particular in losses owing to scattering, may then be observed on the thin-layers deposits.

Documents [3] and [4] indicate the possibility of dispersing copper or silver particles in various organic polymers, such as poly(vinyl methyl ketone), PVC, poly(vinylidene fluoride) or nylon-11. The solubilisation of these polymers in organic solvents of tetrahydrofuran and acrylonitrile type makes it possible to provide good stability of the metal particles. In these documents, non-functionalised metal particles, and not functionalised metal oxide or oxyhydroxide colloidal nanoparticles, are used.

In addition, these documents do not describe the preparation of organic-inorganic hybrid material, and in particular of inorganic-organic hybrid material in the form of thin layers of optical quality.

Document [5] concerns nanocomposites containing an organic matrix, in particular made of a polymer and nanoparticles, each of these nanoparticles comprising at least one nanocrystal of metal sulphide, the surface of which is modified with a carboxylic acid with at least one aryl group.

The nanoparticles are prepared by forming a solution of a salt of a non-alkali metal and carboxylic acid in an apolar, aprotic solvent and by adding a sulphide to this solution and precipitating the nanoparticles formed by adding a third solvent.

The nanocomposites are prepared by mixing the nanoparticles with the organic matrix so as to dissolve the nanoparticles. If the organic matrix comprises monomers which are polymerisable, curable under the effect of heat or irradiation, an initiator is added to the mixture and the polymerisation, curing is carried out by irradiation or heating.

It is also possible to dissolve the nanoparticles and the organic matrix in a solvent such as methylene chloride and then to subsequently remove the solvent by evaporation.

These nanocomposites can be used in optical applications.

In this document, the nanoparticles are not prepared by means of a sol-gel process in a polar, protic medium.

In addition, the teachings of this document apply specifically to sulphides such as ZnS, which is transparent in the infrared, and can in no way be easily transposed to particles of other materials, such as oxides, for instance ZnO, which are transparent in the visible spectrum.

Document [6] describes coating solutions comprising surface-modified nanoparticles, a first liquid and a second liquid, the nanoparticles being more compatible with the first liquid than with the second liquid. After application to a substrate, the first liquid is removed, for example, by evaporation and the other liquid generally forms a film.

The first liquid can be chosen in particular from aliphatic, alicyclic and aromatic organic solvents such as toluene, alcohols, ketones, aldehydes, amines, amides, esters, glycols, ethers, etc.

The second liquid can be a liquid which is polymerisable, curable under the effect of heat, irradiation or moisture.

The nanoparticles may be inorganic nanoparticles, for example nanoparticles of metal oxides such as silica, zirconia, titanium oxide, tin oxide, etc. The nanoparticles may in particular be in the form of colloidal dispersions, for example, of zirconium oxide or of titanium oxide.

However, it is not absolutely specified whether the colloidal particles are prepared by means of a hydrolysis/condensation process such as a sol-gel process or whether the dispersions are dispersions in a polar or protic solvent.

The groups modifying the surface of the nanoparticles are chosen so as to make the nanoparticles compatible with at least one of the liquids; thus, when the liquid is hydrophobic, for example toluene, ketones and acrylates, the surface groups will be chosen so as to provide compatibility with this hydrophobic liquid.

Among the surface-modifying groups, mention is made of silanes, organic acids and bases, and alcohols.

In the examples, coating solutions are prepared with silica surface-modified with trialkoxysilane coupling agents so as to render it hydrophobic, poly(methyl methacrylate), toluene and 1-methoxy-2-propanol acetate, and these solutions are deposited onto glass slides.

More specifically, among the surface-modified silicas A, B and C on page 7 of this document, only the silica C is in the form of a solution, which is a clear blue, low viscosity solution, the solvent of which is not specified. The other silicas A and B are predried.

The silicas A and B, 1-methoxy-2-propanol acetate and toluene are added to a solution of PMMA in toluene so as to give coating solutions ([0099]—page 7).

The solution C is mixed with HDDA (1,6-hexanediol diacrylate) so as to give a viscous gel which is added to a mixture of HDDA and THF. There is therefore no solvent exchange, but simply addition and mixing of solvents. Darocur®, which is a curing agent, is added to the mixture obtained (Example 14, paragraphs [0105] and [0106], page 8).

In this document, soluble monomers which subsequently polymerise, and not an already prepared and formed polymer, are added to the nanoparticles; and in the case where the nanoparticles are in suspension (C), a compound (HDDA) and then a curing agent, and not an already formed polymer, are added to said suspension.

Consequently, the process of this document cannot be carried out with all polymers. In particular, the process of this document excludes all polymers which cannot be prepared by in-situ polymerisation from soluble monomers; this is in particular the case of polytetrafluoroethylene (Teflon®).

Document [7] concerns a colloidal system of inorganic oxide nanoparticles in a dispersing medium such as water, alcohol, tetrahydrofuran, halogenated hydrocarbons, dilute sodium hydroxide lye, dilute acids, hydrocarbons and aromatic hydrocarbons.

The nanoparticles are in particular nanoparticles of titanium oxide, of zirconium oxide, of aluminium oxide, of iron oxide, of barium titanate or of ITO (indium tin oxide).

In order to stabilise the system, these particles are surface-modified and functionalised with inorganic acids, beta-diketones; isocyanates; organic acids; acid chlorides, esters, silanes, polycarboxylic acids.

These colloidal systems make it possible to improve certain ceramic components or plastics. They can be used as fillers for thermal insulation or sound insulation, in nanofiltration diaphragms, in gas detectors, sensors, or in hollow ceramic fibres.

This document neither describes nor suggests the addition of organic polymers to these colloidal dispersions, nor the deposit thereof in the form of thin films, in particular for producing hybrid thin layers of optical quality.

Document [8] relates to blends of immiscible polymers, the morphology and microstructure of which are altered by nanoparticles surface-modified, in particular, with silanes, organic acids, organic bases and alcohols. These nanoparticles can be inorganic particles, such as silica, zirconia, titanium oxide, cerium oxide, alumina, iron oxide, vanadium oxide, antimony oxide or tin oxide particles.

The nanoparticles facilitate the uniform distribution of the disperse phase of the polymer blend in the continuous phase of this blend.

Various processes can be used to combine the surface-modified nanoparticles and the continuous phase. For example, it is possible to combine a colloidal dispersion of surface-modified nanoparticles and the continuous phase, and then the solvent is removed and the continuous phase, in which the surface-modified nanoparticles are dispersed, is obtained.

If the colloidal dispersion is an aqueous dispersion, before the addition of the continuous phase, a cosolvent may be added so as to facilitate water removal. After the addition of the continuous phase, the water and the cosolvent are removed.

In the example of this document, a mixture of an acrylic adhesive forming the continuous phase and of a Kraton polymer forming the dispersed phase is prepared, by extrusion, with addition of porous silica particles surface-modified with a silane.

In this document, the polymer is not solubilised in a solvent, and a pasty mixture is simply prepared with a view to extrusion.

In addition, the preparation of thin films, in particular of thin films with optical properties, from these mixtures, is neither described nor suggested.

Document [9] concerns the dispersion of tungsten oxide nanoparticles in polyacrylonitrile, which is itself dissolved in dimethylformamide. This document does not envisage the functionalisation of the surface of the nanoparticles in order to improve the dispersion of the nanoparticles in an organic medium. Furthermore, the solvent envisaged is not suitable for the preparation of thin films via the liquid approach, since its saturating vapour pressure is too low. The preparation of thin films by means of this method produces films which exhibit surface inhomogeneities.

Document U.S. Pat. No. 5,134,021 [10] describes an anti-fogging film which comprises at least two layers of a cured film on a substrate, said cured film comprising, as main components: (A) polyvinyl alcohol (PVA) and (B) at least one compound chosen from colloidal silica, an organic silicon compound and the product of hydrolysis of said organic silicon compound. The organic silicon compound acts as a binder and the purpose thereof is not to make the silica compatible with a solvent, but rather to impart anti-fogging properties on the film.

In the examples, an aqueous solution of PVA is prepared, and then a hydrolysed silane and a sol of silica in methanol are added to this solution. Next, dioxane and a fluorinated surfactant, and also aluminium acetylacetonate (catalyst), are added to this mixture so as to obtain a coating composition.

In this document [10], a solution of silica surface-grafted with a silane in an apolar aprotic solvent is not really prepared.

This is because the hydrolysed silane and then a methanolic silica sol are added to an aqueous solution of PVA, and then 1,4-dioxane is added thereto: the mixture obtained therefore remains essentially water- and methanol-based and there is no solvent exchange.

No compatibilisation problem arises since the solvents used are always essentially polar solvents and the polymer (PVA) is water-soluble.

Document FR-A-2 681 534 [11] describes concentrated colloidal solutions of nonaggregated monocrystalline particles of metal oxides in a nonaqueous solvent.

These particles are prepared by complexation, in a nonaqueous solvent medium, of a compound such as a metal alkoxide with a ligand, then hydrolysis and condensation of the complex formed, using an aqueous solution of a strong acid. At the end of this step, a sol of amorphous particles of metal oxides, the surface of which is protected by the complexants, ligands, is obtained.

In this document, an already formed polymer is not used and no solvent exchange step is carried out. The solvent is always a nonaqueous solvent.

Document U.S. Pat. No. 4,478,909 [12] has a content substantially analogous to that of document [10].

It describes an anti-fogging film comprising a cured film derived from (A) a polyvinyl alcohol; (B) finely divided silica; and (C) a compound chosen from organic silicon compounds and hydrolysates thereof.

Since the content of this document [12] is substantially analogous to that of document [10], the same conclusions apply to this document.

Document U.S. Pat. No. 4,170,690 [13] describes a coating composition, in particular for imparting abrasion resistance to thermoplastic substrates, which comprises a colloidal silica and a mixture of a dialkyldialkoxysilane and an alkyltrialkoxysilane.

This coating composition is prepared by adding a mixture of a dialkyldialkoxysilane and an alkyltrialkoxysilane to a colloidal silica hydrosol and adjusting the pH.

In Example 1, a coating composition comprising water, colloidal silica, acetic acid, methyl trimethoxysilane, and dimethyl dimethoxysilane is prepared and is diluted to 20% solids with isopropanol.

In this document, the coating composition does not contain polymer and no solvent exchange is carried out. The solvent is always an essentially aqueous, polar solvent.

Document FR-A-2 882 746 [14] describes a process for preparing a sol-gel solution and the use of this solution to form a coating to protect a substrate having a metal surface.

More specifically, the process comprises the following steps:

a) preparing a sol-gel solution by bringing one or more molecular metal and/or metalloid precursors into contact with a medium comprising an organic solvent;

b) adding at least one mercaptoorganosilane compound to the solution obtained in a);

c) hydrolysing the solution obtained in b);

d) adding one or more complexing agents to the solution obtained in c).

To prepare a coating material, a layer of the sol-gel solution prepared as described above is deposited onto the substrate and the deposited layer is crosslinked-densified.

In this document, there is absolutely no question of colloidal oxide or oxyhydroxide particles being present.

This is because this document concerns the “sol-gel polymer” technique in which a network of metal oxyhydroxydes, an inorganic polymer, is formed, and not colloidal particles.

A fortiori, this document does not describe the preparation of particles surface-functionalised by reaction with an organic compound.

The process of this document does not comprise a step of grafting an organic compound onto the surface of a particle, nor a solvent exchange step.

Document FR-A-2 680 583 [15] describes a material having antireflective, hydrophobic and abrasion resistance properties. This material comprises, in particular, an antireflective sol-gel layer formed from colloids of silica in a siloxane binder. This layer is prepared from a sol-gel solution, which is itself prepared by hydrolysing a precursor, for example TEOS, in a basic medium. In parallel, the precursor is also hydrolysed in an acidic medium in order to produce the soluble siloxane binder.

In this document, the silica is not surface-functionalised by reaction with an organic compound.

This is because the silica is simply coated without a chemical reaction taking place between the siloxane and the surface of the silica.

This document absolutely does not describe a process comprising steps of grafting an organic compound onto the surface of particles and of solvent exchange.

There exists therefore, with regard to the above, a need for an organic, inorganic hybrid, composite material which comprises colloidal particles of at least one inorganic compound chosen from metal or metalloid oxides and oxyhydroxides, these particles being specifically particles prepared by the sol-gel process in a protic medium.

There also exists a need for an organic-inorganic hybrid, composite material which can be readily formed, shaped, into thin layers of excellent optical quality.

### DESCRIPTION OF THE INVENTION

The goal of the present invention is to provide an organic-inorganic hybrid, composite material which meets, inter alia, this need.

The goal of the present invention is also to provide an organic-inorganic hybrid, composite material which does not have the drawbacks, defects, limitations and disadvantages of the materials of the prior art and which solves the problems of the hybrid, composite materials of the prior art.

This goal, and others, are achieved in accordance with the invention by means of an organic-inorganic composite (hybrid) material comprising:
colloidal particles of at least one inorganic compound chosen from metal or metalloid oxides and oxyhydroxides prepared by means of a process of hydrolysis-condensation in a protic or polar solvent, said particles having been surface-functionalised by reaction with an organic compound;
and an organic or inorganic polymer.

The hydrolysis-condensation process by which the colloidal particles are prepared is generally chosen from hydrothermal processes and sol-gel processes, the latter being preferred.

The terms “hydrothermal processes” and “sol-gel processes” are widely used in this technical field and have a well-established meaning known to the man skilled in the art.

Hydrothermal processes use a reaction medium under pressure and at temperature, in which the hydrolysis-condensation and crystallisation reactions are kinetically favoured.

Sol-gel processes call for synthesis from inorganic precursors such as salts, or from organometallic precursors such as alkoxides, or metal oxides under “mild” temperature and pressure conditions, namely, in general, at atmospheric pressure and at a temperature of less than 100° C.

The colloidal particles can have any shape; they may, for example, be spherical or quasi-spherical particles, spheroidal particles, polyhedral particles, or anisotropic particles having in particular the shape of platelets or of rice grains.

The colloidal particles generally have an average size, defined for example by their characteristic dimension, which is the diameter in the case of spherical or spheroidal particles, of from 1 to 100 nm, preferably from 2 to 50 nm.

The metal or metalloid oxides can be chosen from oxides which are transparent, in particular in the visible spectrum, or coloured. These oxides can in particular be chosen from scandium, yttrium, lanthanum, titanium, zirconium, hafnium, thorium, niobium, strontium, tantalum, cerium, antimony, tin, nickel, magnesium, manganese, iron, cobalt, germanium and silicon oxides; mixed oxides thereof; and mixtures of these oxides and mixed oxides.

The metal or metalloid oxyhydroxides can be chosen from oxyhydroxides which are transparent, in particular in the visible spectrum, or coloured.

These oxyhydroxides can in particular be chosen from scandium, yttrium, lanthanum, titanium, zirconium, hafnium, thorium, niobium, strontium, tantalum, cerium, antimony, tin, nickel, magnesium, manganese, iron, cobalt, germanium and silicon oxyhydroxides; mixed oxyhydroxides thereof; and mixtures of these oxyhydroxides and mixed oxyhydroxides.

The protic or polar solvent can be chosen from water; saturated or unsaturated aliphatic alcohols of formula ROH, where R represents an alkyl group having from 1 to 30 carbon atoms or a phenyl group; diols of formula HOR′OH, where R′ represents an alkyl group having from 1 to 30 carbon atoms or a phenyl group; and mixtures thereof.

Preferably, the protic or polar solvent is methanol.

The organic compound, the reaction of which with the surface of the particles enables the functionalisation of said particles, in other words the organic compound which is grafted onto the surface of the particles, is preferably an organosilane or a complexing molecular compound.

The organosilane can correspond to the following formula (I):

(R¹)ₓ-SiX₍₄₋ₓ₎

where R¹ is an alkyl group having from 1 to 10 carbon atoms; X is a hydrolysable group such as a halide, an acetonate, a carbonate, a sulphate, an acrylate or an alkoxide of formula OR² where R² is an alkyl group having from 1 to 10 carbon atoms, and x is 1, 2 or 3.

Preferably, the organosilane corresponds to the following formula (II):

R¹Si(OR²)₃

where R¹ and R² independently represent alkyl groups having from 1 to 10 carbon atoms.

The organosilane can, in general, be chosen in particular from (C1 to C10)alkoxysilanes, for example methyltrimethoxysilane, ethyltrimethoxysilane, ethyltriethoxysilane, n-propyltrimethoxysilane, n-propyltriethoxysilane, i-propyltrimethoxysilane, propyltriethoxysilane, butyltrimethoxysilane, butyl-triethoxysilane, hexyltrimethoxysilane, n-octyltri-methoxysilane, n-octyltriethoxysilane, vinyltrimethoxy-silane, vinyldimethylmethoxysilane, vinyldimethyl-cetoxysilane, vinylmethyldiethoxysilane, vinyltri-acetoxysilane, vinyltriethoxysilane, vinyltrisopropoxy-silane, vinyltrimethoxysilane, vinyltriphenoxysilane, vinyltri(t-butoxy)silane, vinyltris(2-methoxyethoxy)-silane; tri(C1 to C10)alkoxy(C6 to C10)arylsilanes; isooctyltrimethoxysilane; silanes comprising a (meth)acrylate function, such as for instance (methacryloyloxy)propyltriethoxysilane, (methacryloyl-oxy)propyltrimethoxysilane, (methacryloyloxy)propyl-methyldimethoxysilane, (methacryloyloxy)methyltri-methoxysilane, (methacryloyloxy)propyldimethylmethoxy-silane; polydi(C1 to C10)alkylsiloxanes, including, for example, polydimethylsiloxane; (C6 to C10)arylsilanes, including, for example, substituted or unsubstituted arylsilanes, (C1 to C10)alkylsilanes, including substituted or unsubstituted alkylsilanes, including, for example, alkylsilanes comprising methoxy and hydroxyl substituents; fluorosilanes, for instance 3,3,3-trifluoropropyltrimethoxysilane, (tridecafluoro-1,1,2,2-tetrahydrooctyl)triethoxysilane or (heptadeca-fluoro-1,1,2,2-tetrahydrodecyl)triethoxysilane.

The complexing organic compound may be chosen from carboxylates of formula R³COO⁻ in which R³ is a linear or branched alkyl group having from 1 to 30 carbon atoms, preferably from 1 to 10 carbon atoms, or a phenyl group; β-diketonates and β-diketonate derivatives, for example of formula R⁴COCHCO⁻—R⁵, in which R⁴ and R⁵ are chosen independently from a linear or branched alkyl group having from 1 to 30 carbon atoms, preferably from 1 to 10 carbon atoms, or a phenyl group; phosphonates, for example chosen from the group constituted of R⁶PO(OH)₂, R⁷PO(OR⁸)(OH) or R⁹PO(OR¹⁰)(OR¹¹) in which R⁶, R⁷, R⁸, R⁹, R¹⁰ and R¹¹ are identical or different, linear or branched alkyl groups having from 1 to 30 carbon atoms, preferably from 1 to 10 carbon atoms, or a phenyl; hydroxamates of formula R¹²CO(NHOH) in which R¹² is a linear or branched group having from 1 to 30 carbon atoms, preferably from 1 to 10 carbon atoms, or a phenyl group; diolate groups of formula ⁻OR¹³—OH where R¹³ is a linear or branched alkyl group having from 1 to 30 carbon atoms, preferably from 1 to 10 carbon atoms, or a phenyl group.

The organic polymer is generally chosen from polymers which are soluble in apolar, aprotic solvents, examples of which are given below.

The term “soluble” in these solvents is generally intended to mean that the polymer is soluble in a proportion of from 1% to 99% by mass relative to the total mass of the solution.

The organic polymer may in particular be chosen from polyvinyl polymers, for example polyvinyl alcohol, polyvinylpyrrolidone and polyvinylbutyral; polysiloxanes, for example polydimethylsiloxane; polymethacrylates; polyacrylates; polyesters; polyether-esters; polyurethanes; fluorinated polymers and copolymers, such as poly(vinylidene fluoride) and the PVdF/HFP copolymer or polytetrafluoroethylenes, such as Teflon® AF; polystyrenes; polycarbonates; polysilazanes; polyvinylcarbazoles; polyphosphazenes; and blends constituted of the abovementioned polymers.

If the polymer is inorganic, this generally involves soluble species polymerised from organometallic precursors, the organic part of which is generally branched and comprises, for example, vinyl, acrylate or perfluoro functions, like 3,3,3-trifluoropropyltrimethoxysilane.

The material according to the invention is preferably in the form of a thin layer having a thickness of generally from 1 to 1000 nm, preferably from 10 to 500 nm, more preferably from 50 to 100 nm.

This thin layer is preferably an “optical” thin layer. This term is defined below.

Preferably, this thin layer is a thin layer which is transparent in a range of wavelengths between ultraviolet and near infrared, including the visible spectrum, and this layer is a layer of “optical quality” as defined above.

However, the material according to the invention can also be in the form of a coloured layer, for example of an absorbent coloured thin layer in the case, for example, where the oxide or the oxyhydroxide is coloured.

It should be noted that the final material (in particular after drying), for example in the form of a layer, may also contain residual aprotic, apolar solvent in a proportion of generally less than 2% by mass of the mass of the material.

The invention also relates to a process for preparing a solution of an organic-inorganic composite (hybrid) material, as described above, in an apolar, aprotic solvent, in which the following successive steps are carried out:
preparation of a suspension (1), or sol, of colloidal particles of at least one inorganic compound chosen from metal or metalloid oxides and oxyhydroxides, prepared by means of a hydrolysis-condensation process, in a protic or polar solvent (2);
mixing of the suspension (1) with an organic compound (3) capable of surface-functionalising the particles, said organic compound being optionally dispersed in the same protic solvent (2), so as to obtain a suspension (4);
reaction, grafting of the organic compound (3) onto the surface of the particles (2), whereby (in return for which) a suspension (5) of particles surface-functionalised with the organic compound (3) is obtained;
exchange of the protic solvent (2) of the suspension (5) with an apolar, aprotic organic solvent (6) so as to obtain a suspension (7) of particles surface-functionalised with the organic compound (3) in the apolar, aprotic organic solvent (6);
solubilisation of an organic or inorganic polymer in the solvent (6) so as to obtain a polymer solution (9);
mixing of the suspension (7) and of the solution (9) with stirring so as to obtain an organic-inorganic hybrid solution (10).

The term “suspension” can also be used to denote the solution (10) since, on the microscopic scale, it is a suspension which macroscopically has the appearance of a solution.

Likewise, the suspension (4) could be termed “solution”.

The invention also relates to a process for preparing an organic-inorganic hybrid, composite material, in which a solution of an organic-inorganic composite (hybrid) material is prepared in an apolar, aprotic solvent by means of the process described above, this solution is deposited, applied onto a substrate and the solvent of the solution is evaporated off.

Preferably, the organic-inorganic hybrid, composite material thus prepared is in the form of a thin layer, the thickness of which has already been defined above, on a substrate.

Preferably, this material is transparent and the substrate is itself also, preferably, transparent.

The process, according to the invention, for preparing a solution of an organic-inorganic composite (hybrid) material, and the subsequent process, according to the invention, for preparing an organic-inorganic hybrid, composite material, comprise a series of specific steps which has never been described or suggested in the prior art.

Contrary to the process of the prior art, the process according to the invention enables, surprisingly, the compatibilisation of an inorganic, mineral phase, prepared in a protic, apolar medium, for example an aqueous or aqueous-alcoholic medium, with an organic phase comprising a solvent or a polymer solution, which is essentially or even exclusively aprotic, apolar. Consequently, metal oxide or oxyhydroxide nanoparticles prepared with all the known advantages of the sol-gel process in a protic, polar medium can be used with all types of solvents and not only with polar, protic solvents, and also with all types of polymers and not only with polymers that are soluble in polar protic solvents.

The choice of the polymers which can be used with these nanoparticles is therefore considerably broadened, in particular to all polymers that are soluble in apolar and aprotic media, which can provide access to a large variety of properties that can be modulated as desired for the final hybrid material.

In addition, in the process according to the invention, the polymer which is solubilised in the solvent (6) is an already synthesized polymer, and it is this already formed polymer which is mixed with the solvent.

The polymer is not prepared by in-situ polymerisation from soluble monomers as in document [6], which, again, considerably broadens the range of polymers which can be used.

In the process according to the invention, the grafting, at the surface of the inorganic nanoparticles, of a crown of organic molecules provides stabilisation of said nanoparticles in an organic medium which is a solvent or a polymer solution completely different from the polar, protic medium in which they were initially prepared.

An organic-inorganic hybrid suspension, solution which is stable over time, for generally one or more months, for example from 1 month to 6 months, is thus obtained by virtue of the process of the invention.

For the purpose of the invention, the term “suspension, solution which is stable” is generally intended to mean that no phase separation is observed, that there is no precipitation or settling out of a solid phase, no flocculation, aggregation or demixing.

The stability generates the preparation of a layer, for example a thin layer, with for example constant optical properties, in particular with regard to the refractive index.

The polymer is generally soluble in apolar, aprotic solvents, but not in the polar, protic solvents in which the inorganic nanoparticles were prepared, and by virtue of the process according to the invention, a stable suspension, solution is obtained in which the nanoparticles, the apolar, aprotic solvent and the polymer that is soluble in the latter cohabit in a completely compatible manner.

In the suspension, solution prepared by means of the process according to the invention, the polymer coats the particles, which are themselves already functionalised, grafted, stabilised, and this thus gives a composite hybrid system which has the advantage of behaving like a conventional medium and which can be readily used through a process of depositing by means of an established conventional liquid process.

Up until now, solutions of polymers that are soluble in an apolar, aprotic solvent, such as butanone, or else solutions of oxides such as silica, in water or alcohol, were available. Stable polymer solutions loaded with mineral particles prepared in a protic medium are now available by virtue of the process of the invention, and the advantages of the two solutions are combined.

The processes according to the invention also enable:
deposition in the form of a coating with a controlled organic/inorganic composition, which is advantageously transparent from the ultraviolet to the near infrared, and which has an excellent optical quality (generally with no absorption or scattering);
control of the refractive index of the hybrid films deposited by virtue of the composition of the solution defined by the proportion of organic phase relative to the inorganic phase. Specifically, the higher the proportion of inorganic phase, the higher the refractive index.

The invention will now be described in detail in the description which follows, which is given for illustration and nonlimiting purposes and in relation to the process for preparing a solution of an organic-inorganic hybrid material and the preparation of an organic-inorganic hybrid material according to the invention, with reference to the attached drawings, in which:

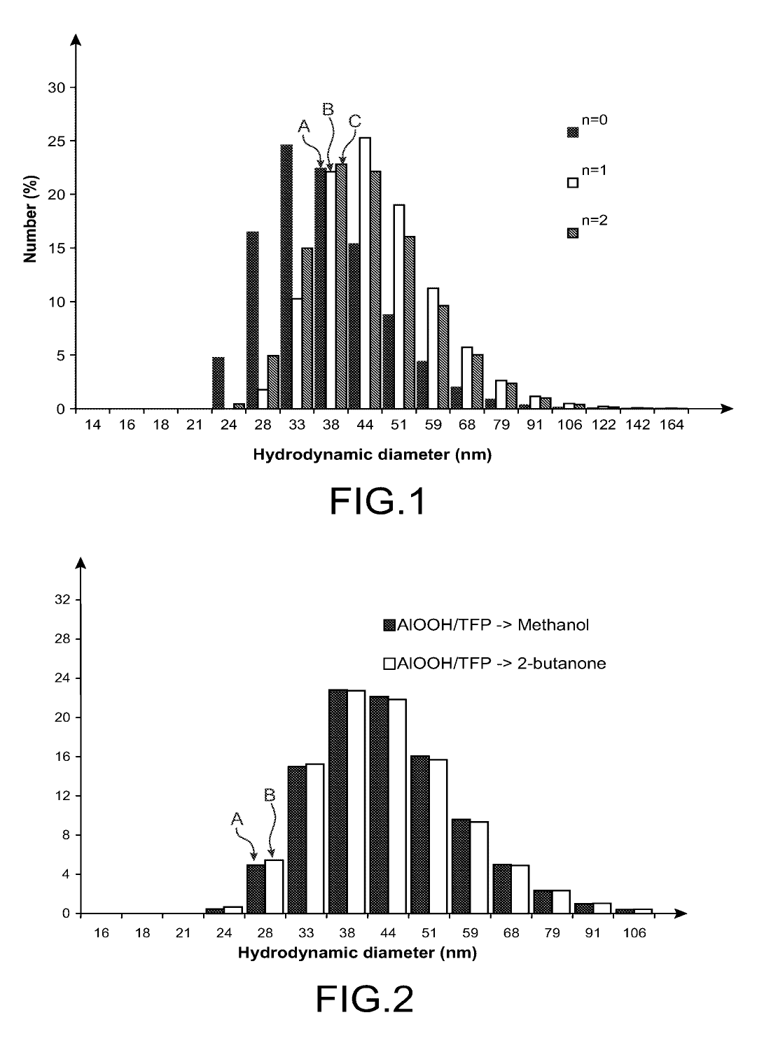

FIG. 1 is a graph which represents the percentage by number (number (%)) of functionalised particles in the suspension (5), the solvent of which is methanol, prepared in Example 1, having a given hydrodynamic diameter (in nm); as a function of various n_{TFP}/n_{AlOOH} molar ratios, namely n=0 (black bars A); n=1 (white bars B), and n=2 (grey bars C). The average diameter D for n=0, 1 or 2 is, respectively, 29 nm, 44 nm and 38 nm.

FIG. 2 is a graph which compares the percentage by number (number (%)) of (AlOOH/TFP) functionalised particles having a given hydrodynamic diameter (in nm) respectively in the suspension (7), the solvent of which is 2-butanone, and in the suspension (5), the solvent of which is methanol 2, prepared in Example 1; the black bars A (on the left in each pair of bars) relate to the suspension in methanol and the white bars B (on the right in each pair of bars) relate to the suspension in 2-butanone.

The average diameter D of the particles in methanol is 39 nm and the average diameter D of the particles in 2-butanone is 38 nm.

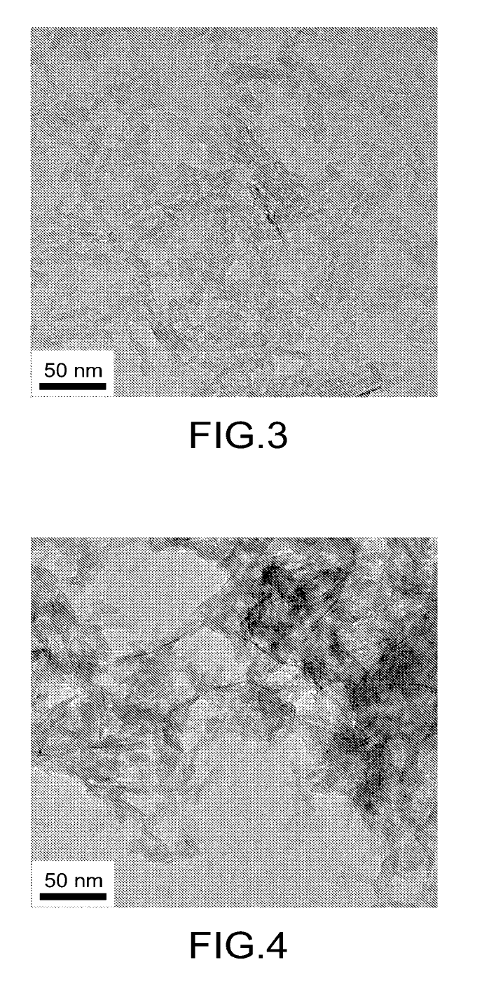

FIG. 3 is a transmission electron microscopy (TEM) photograph of AlOOH before grafting of trifluoropropyl-trimethoxysilane (TFP), the scale indicated on the figure represents 50 nm.

FIG. 4 is a transmission electron microscopy (TEM) photograph of AlOOH after grafting of trifluoropropyl-trimethoxysilane (TFP), the scale indicated on the figure represents 50 nm.

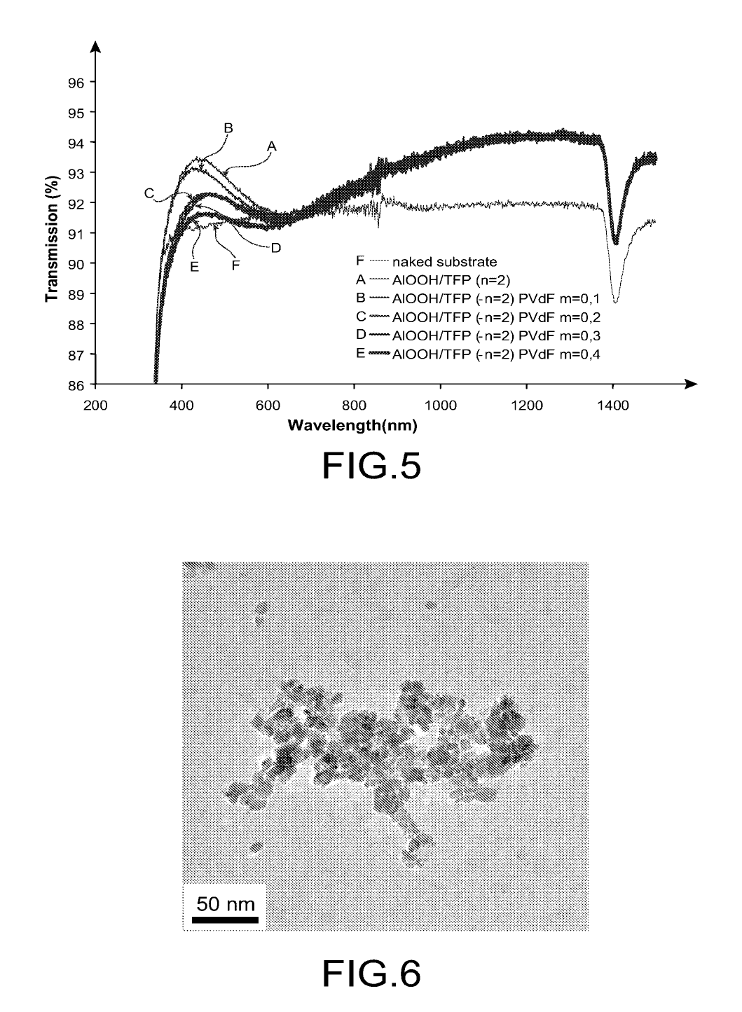

FIG. 5 represents the UV and visible spectra of a thin layer, having a thickness of 210 nm, of the AlOOH-TFP-functionalised oxyhydroxide prepared from a suspension of AlOOH-TFP with a ratio n of the number of moles of oxyhydroxide to the number of moles of TFP equal to 2 (spectrum A); of a thin layer of the hybrid material comprising nanoparticles of the AlOOH-functionalised oxyhydroxide and 10% by mass of a poly(vinylidene fluoride) cohexafluoropropylene (PVdF/HFP) copolymer, prepared from a suspension of AlOOH-TFP (n=2) with 10% by mass of PVdF/HFP polymer (ratio by mass m of the polymer to the functionalised oxyhydroxide=0.1) (spectrum B); of a thin layer of the hybrid material comprising nanoparticles of the AlOOH-functionalised oxyhydroxide and 20% by mass of a PVdF/HFP copolymer prepared from a suspension of AlOOH-TFP (n=2) with 20% by mass of PVdF/HFP polymer (m=0.2) (spectrum C); of a thin layer of the hybrid material comprising nanoparticles of the AlOOH-functionalised oxyhydroxide and 30% by mass of a PVdF/HFP copolymer prepared from a suspension of AlOOH-TFP (n=2) with 30% by mass of PVdF/HFP polymer (m=0.3) (spectrum D); of a thin layer of the hybrid material comprising nanoparticles of the AlOOH-TFP-functionalised oxyhydroxide and 40% by mass of a PVdF/HFP polymer prepared from a suspension of AlOOH-TFP (n=2) with 40% by mass of PVdF/HFP polymer (m=0.4) (spectrum E); and, finally, of the uncoated, naked, substrate (spectrum F); the wavelength (in nm) is represented along the x-axis and the transmission (as %) is represented along the y-axis.

FIG. 6 is a transmission electron microscopy (TEM) photograph of ZrO₂ before grafting of trifluoroporopyl-trimethoxysilane (TFP), the scale indicated on the figure represents 50 nm.

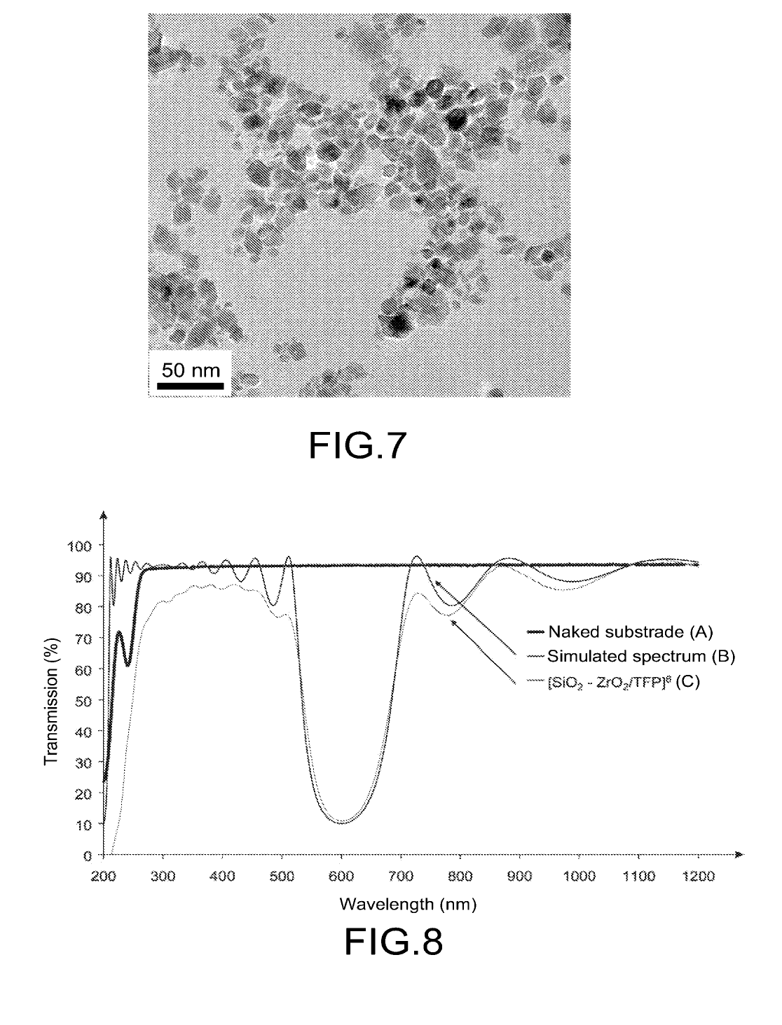

FIG. 7 is a transmission electron microscopy (TEM) photograph of ZrO₂ after grafting of trifluoroporopyl-trimethoxysilane (TFP), the scale indicated on the figure represents 50 nm.

FIG. 8 represents the UV and visible spectra of a stack comprising, on a substrate, six pairs of layers; each pair comprising a layer of silica and a layer of TFP-grafted ZrO₂ hybrid material; curve A is the spectrum of the naked, uncoated, substrate, spectrum B is the simulated spectrum of the [SiO₂/ZrO₂-TFP]⁶ stack on the substrate and spectrum C is the experimental spectrum of the [SiO₂/ZrO₂-TFP]⁶ stack on the substrate.

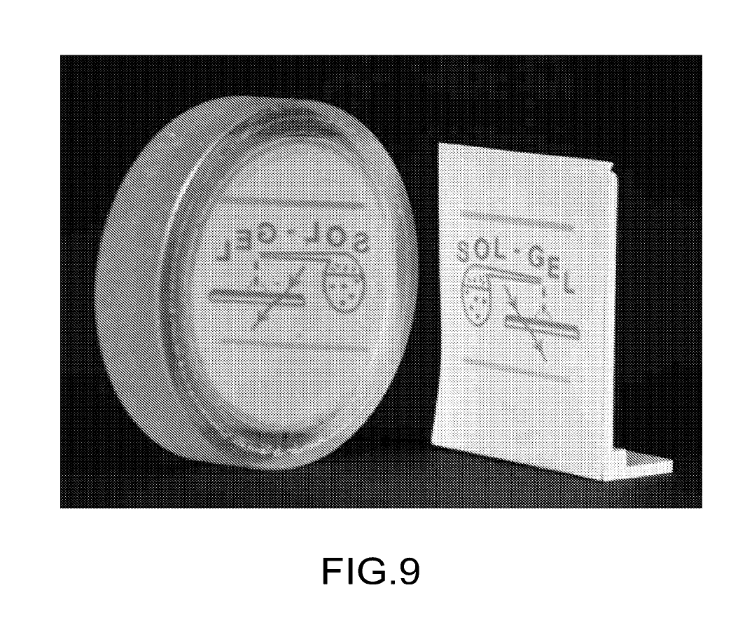

FIG. 9 is a photograph of the mirror stack prepared in Example 3.

The first step of the process, according to the invention, for preparing a solution of the organic-inorganic hybrid material in an aprotic, apolar solvent consists in preparing a suspension (1).

It consists in synthesizing, from inorganic, ionic (salts) or organometallic precursors, such as alkoxides, in a polar solvent, the colloidal particles of inorganic compound. These colloidal particles have already been defined above, both with respect in particular to their nature and their structure, or their size.

These particles are stable in the solvent (2); they are non-aggregated.

The polar or protic solvent (2), of the suspension (1), has also already been defined above. A preferred polar or protic solvent is methanol.

The colloidal particles are prepared in a polar or protic solvent and they can remain in the same polar or protic solvent in which they have been prepared, so as to give the suspension or the sol of particles (1) in the same polar or protic solvent (2). However, the polar, protic solvent (2), of the solution (1), such as methanol, can also be different from the polar, protic solvent, such as water, in which the particles have been prepared. For example, the water having served for the synthesis can be replaced with methanol, for example by dialysis.

The polar or protic solvent in which the colloidal particles are prepared, which may be identical to or different from the solvent (2) of the suspension (1), is chosen from the abovementioned polar, protic solvents.

The suspension (4) is obtained by adding, to the solution (1), an organosilane-based molecular compound (3) or a complexing molecular compound.

The molecular compound has already been described in detail above.

The molecular compound can be optionally dispersed and/or dissolved in a solvent of the same nature as the solvent (2), preferably in the same solvent (2) as that of the solution (1).

The molecular organic compound (3) can be added in a proportion of from 1% to 99% by mass, for example from 5% to 50% by mass, relative to the mass of inorganic compound chosen from metal or metalloid oxides and oxyhydroxides.

The grafting, reaction, of the organic compound (3) onto, on the surface of the particles (2), in other words the preparation of the suspension (5), are generally carried out by heat treatment, for example by bringing to the reflux of the solvent (2) of the suspension (4), resulting in functionalisation of the particles.

The apolar aprotic organic solvent (6) is exclusively a saturated or unsaturated, aliphatic or cyclic, anhydrous organic solvent comprising one or more alkyl groups having from 1 to 30 carbon atoms, or one or more aromatic groups such as phenyl groups, and can be chosen in particular from ketones, for example acetone, 2-butanone; tetrahydrofuran; 1,4-dioxane; toluene; styrene; cyclohexane; acetonitrile; amides; fluorinated solvents, such as Galden® HT110; ethers; esters and mixtures of the abovementioned solvents. The solvent (6) will preferably be chosen from solvents having a saturation vapour pressure of between 50 and 200 mbar. The solvent (6) should, in addition, preferably be able to enable the deposit of thin layers of optical quality. Preferably, the organic solvent (6) is 2-butanone, tetrahydrofuran or 1,4-dioxane.

The exchange of the protic solvent (2) of the suspension (5) with the apolar, aprotic organic solvent (6) can be carried out by azeotropic distillation or by dialysis of the suspension (5) against(to) the organic solvent (6) so as to obtain the suspension (7) in which the nanoparticles are stabilised in the organic solvent (6).

Specifically, the molecular compound (3) essentially has the function of stabilising the colloids in the organic solvent (6).

The amount of molecular organic compound (3) introduced into the organic-inorganic hybrid solution makes it possible to control the stability thereof. This amount is generally from 5% to 50% by mass, relative to the mass of the inorganic compound.

In the next step of the process, an organic polymer is solubilised in the solvent (6) so as to obtain a polymer solution (9).

The organic polymer may be chosen from the abovementioned polymers, preferably from polymers that are soluble in aprotic, apolar solvents.

The solubilisation of the polymer in the solvent (6) is generally carried out in the following way:
mixing the polymer and the solvent;
stirring, generally magnetic stirring, for, for example, 3 hours;
heating, for example, to 40° C. so as to promote dissolution, preferably with the application of ultrasound.

The resulting solution of the organic polymer (8) solubilised in the solvent (6) is mixed with the suspension (7) with stirring so as to obtain the organic-inorganic hybrid solution (10).

Generally, this stirring is mechanical and/or magnetic stirring, and an ultrasound treatment can be carried out during or after said stirring.

The organic polymer/inorganic compound (i.e. oxide or oxyhydroxide) ratio by mass is generally between 1% and 99%, preferably between 5% and 50%, for example 10%.

The invention also relates, as has already been specified above, to a process for preparing the organic-inorganic hybrid, composite material which has been described in detail above, in which a solution of an organic-inorganic composite (hybrid) material, in an apolar, aprotic solvent, is prepared by means of the process described above, this solution is deposited, applied onto a substrate and the solvent of the solution is evaporated off.

Preferably, the organic-inorganic hybrid, composite material thus prepared is in the form of a thin layer on a substrate.

It was seen above that the term “thin layer” was generally intended to mean a layer having a thickness of from 1 to 1000 nm, preferably from 10 to 500 nm, more preferably from 50 to 100 nm.

This layer is preferably a transparent layer, but it may also be a coloured absorbent layer.

For the purpose of the present invention, the term “transparent” is generally intended to mean that this material, or this layer, has a transparency to radiation having a wavelength of between ultraviolet and near infrared, i.e., for example, from 150 to 2000 nm.

This material, or this layer, is preferably of optical quality; this term has already been defined above.

More specifically, the process for preparing the organic-inorganic hybrid, composite material comprises the following successive steps:
cleaning the surface of the substrate;
rinsing and drying the surface of the substrate;
depositing the solution (10) of organic-inorganic hybrid material (10) onto the substrate so as to form a uniform layer of solution of organic-inorganic hybrid material;
evaporating-off the solvent so as to form a uniform layer of inorganic hybrid material.

The general term “substrate” denotes any organic or inorganic, including metal, substrate, support, such as those which will subsequently be described, or any active layer or layer which promotes adhesion, deposited onto said substrate.

Generally, the substrate is a flat substrate or a substrate with a slight curvature, for example an eyeglass lens, but the process according to the invention makes it possible to coat any substrate irrespective of its shape.

The term “substrate” also comprises substrates comprising a base substrate (for example, glass per se) and a coating or a treatment.

The substrate according to the invention may be any material, but it is generally a substrate made of a transparent material. The term “transparent material” is intended to mean a material through which light rays having wavelengths lying in the spectral range of interest can pass, as was defined above, for example the visible spectrum.

If the substrate is not transparent, it may also be made of a reflecting material, for example of a metal such as gold.

The term “substrate” also comprises substrates comprising a base substrate (for example, glass per se) and a coating or a treatment.

The substrate may be an organic substrate or an inorganic substrate, including a metal substrate.

The term “organic substrate” denotes more specifically a plastic substrate, for example one of those chosen from polyacrylates, poly(methyl methacrylate)s (PMMAs), acetobutyrates, cellulose acetates, diallylglycol carbonates, polyurethanes, ABSs, polycarbonates, polyallylcarbonates and polyamides. However, this list is not limiting and covers more generally organic polymer materials.

The term “inorganic substrate” covers more specifically a mineral substrate, i.e., for example, amorphous or even crystalline materials, and in particular silica, silicon, glasses, such as borosilicate glasses or soda-lime glasses, fluorophosphates and phosphates, and metals in the case of reflecting substrates.

Compared with the mineral substrates, the plastic substrates are first and foremost less expensive, more readily modifiable, lighter and less fragile to impacts. However, their use preferentially requires the presence of an intercalated coat, termed interface coat or varnish, between the organic substrate and the first coat deposited, providing good compatibility at this interface.

The substrate is generally made of a material chosen from polished optical and ophthalmic glasses.

The optical and ophthalmic glasses can be chosen from organic glasses, made of a material as defined above; or from mineral glasses, such as borosilicate glasses, defined above, and glasses with a high refractive index, i.e. generally from 1.7 to 1.9.

The substrate, for example made of a mineral glass, may be provided with no coating.

The cleaning of the substrate, in particular in the case of a glass substrate, can be carried out using one or more cleaning or treating liquids, chosen, for example, from alcohols, acids, soaps, ketones and water. Thus, this cleaning can be carried out using acetone, an aqueous solution of hydrofluoric acid at 1%, deionised water and absolute ethanol, preferably successively in this order.

The rinsing of the substrate, in particular in the case of a glass, can be carried out with deionised water.

During the cleaning and/or the rinsing, ultrasound can also be used.

The drying of the substrate can be carried out with absolute ethanol.

The depositing of the solution (10) in particular onto a substrate can be carried out by any one of the techniques conventionally used for depositing a solution onto a substrate, such as, for example, spray-coating, spin-coating, drop-coating, dip-coating, laminar flow coating or meniscus-coating, soak-coating, roll-to-roll process, tape casting, painting-coating, ink jet printing or screen printing, or by any other process for obtaining a uniform deposit and a layer with a homogeneous thickness.

Among these techniques, preference is given, in particular in the case where it is desired to produce a thin film, to spin-coating, dip-coating and laminar flow coating, because it is these techniques which make it possible to obtain the best control of the thickness of the layers deposited on the substrate.

Whatever the depositing technique used, the solvent present in the solution is eliminated by evaporation, it being possible for said evaporation to occur naturally in the open air or to be facilitated, for example by applying a stream of gas, by thermal or radiative heating provided that the temperature impairs neither the solution nor the underlying substrate, or else by mechanical means such as rotation of the substrate during depositing by spin-coating.

Residual solvent may possibly remain in small proportions in the layer, for example in a proportion of less than 2% by mass of the mass of the layer.

The invention also relates to an optical material comprising a substrate covered with at least one layer, preferably a thin layer, of organic-inorganic hybrid material as defined above.

For the purpose of the invention, the term “optical material” is generally intended to mean a material which exerts an action on a light ray, and in particular on the trajectory of said ray, for example by deflecting it, polarising it, reflecting it, absorbing it or attenuating it.

Such a material has, for example, antireflective properties or else reflective properties, or alternatively polarising, absorbing or attenuating properties.

The refractive index of the layer of organic-inorganic hybrid material can be adjusted by choosing the metal oxide or oxyhydroxide which goes to make up the composition of the colloidal nanoparticles, the nature of the functionalising organic compound, the nature of the polymer, and the functionalising organic compound/metal oxide or oxyhydroxide molar ratio.

The terms “low refractive index”, “medium refractive index” and “high refractive index” should generally be interpreted as meaning that the index is less than approximately 1.4; between approximately 1.4 and 1.6; and greater than approximately 1.6.

In this optical material, the layer of organic-inorganic hybrid material can in particular be a layer with a high refractive index constituted, for example, of a layer of zirconium oxide surface-functionalised with TFP (trifluoropropylmethoxysilane).

The optical material may comprise, in addition to the organic-inorganic hybrid layer, for example with a high refractive index, at least one layer chosen from:
a layer of adhesion promoter;
a layer with a low refractive index;
a layer with a medium refractive index;
a layer of binding agent;
a layer of a coupling agent;
an antiabrasive layer.

Depending on the nature of the layers, of their thickness and of their arrangement with respect to one another, antireflective materials or reflective or polarising or attenuating or absorbing materials can be prepared.

Thus, the optical material can be a reflective material comprising, on a substrate, at least one stack of a layer of organic-inorganic hybrid material with a high refractive index on a layer with a low refractive index. The layer with a low refractive index may be, for example, a layer of colloidal silica and this optical material may comprise from 1 to 50, for example 6 of these stacks.

The invention will now be described with reference to the following examples given by way of nonlimiting illustration.

### Example 1

In this example, a thin layer of organic-inorganic hybrid material comprising colloidal nanoparticles of aluminium oxyhydroxide functionalised with 3,3,3-trifluoropropyltrimethoxysilane (TFP) and a PVdF-HFP copolymer is prepared.

In a first step, a colloidal suspension (1) of aluminium oxyhydroxide (AlOOH) nanoparticles is prepared.

The AlOOH nanoparticles are synthesized on the basis of the protocol described by Yoldas [16]. Hydrochloric acid (HCl), aluminium sec-butoxide (Al-sBu) and water (H₂O) are used in the following molar proportions:

n_{H}_{₂}_{O}/n_{Al-sBu}/n_{HCl}=300/3/0.2.

The particles synthesized in water are dispersed in methanol by dialysis, until a completely methanolic sol containing 5% by mass of oxide is obtained. The molecular compound (3), the 3,3,3-trifluoropropyltrimethoxysilane (TFP), is then added to the solution (1). The organosilane/oxide molar ratio can be between 0.05 and 5, and more specifically between 1 and 3, for example 2.

The suspension (4) thus prepared is stirred magnetically for 30 minutes and kept under an inert nitrogen or argon atmosphere. This suspension (4) is placed at the reflux of methanol for 16 h, under an inert nitrogen or argon atmosphere. The resulting suspension (5) in methanol remains stable for at least two months.

FIG. 1 makes it possible to demonstrate a slight increase in the hydrodynamic diameter of the particles after functionalisation. The diameter is initially 29 nm for the molar ratio n_{TFP}/n_{AlOOH}=0 and changes to become 44 nm for the molar ratio n_{TFP}/n_{AlOOH}=1. This increase in the hydrodynamic diameter, which attests to the grafting, is in all cases limited and the grafting does not lead to aggregation of the particles.

Solvent transfer by azeotropic distillation makes it possible to disperse the grafted nanoparticles in the solvent (6), 2-butanone, and to obtain the solution (7).

FIG. 2 shows that, during the transfer to the organic solvent (2-butanone) by azeotropic distillation, the size of the nanoparticles, expressed by the hydrodynamic diameter, remains approximately constant; it in fact goes from 39 nm to 38 nm in terms of average hydrodynamic diameter, i.e. the functionalisation of the surface of the oxide enables good stabilisation in an organic medium without aggregation.

In other words, there is no aggregation of the particles irrespective of the medium which contains them, whether said medium is polar (methanol) or apolar (2-butanone), which proves the effectiveness of the grafting, contrary, for example, to document [2].

The AlOOH transmission electron microscopy photographs taken before and after grafting show the absence of significant modification of the morphology of the alumina nanoparticles after the grafting step.

Besides, a polymer solution (9) is prepared by solubilising a PVdF/HFP copolymer (8) dissolved in an organic solvent (6): 2-butanone at the concentration of 3%.

The organic-inorganic hybrid solution (10) is obtained by mixing the colloidal suspension (7) and the polymer solution (9). The proportion of polymer is between 10% and 30% of polymer relative to the dry mass of oxyhydroxide and of organosilane.

The solution (10) is stirred for 15 minutes by magnetic stirring, followed by ultrasound treatment for 30 minutes.

The depositing of the solution (10) is carried out by spin-coating.

The substrate is a substrate of molten silica with a diameter of 50 mm. The substrate is cleaned as has already been described above, and the substrate is spun at the speed of approximately 500 rpm. The depositing is carried out with approximately 1 ml of solution (10).

After two minutes of drying at ambient temperature and atmospheric pressure, a homogeneous layer of organic-inorganic hybrid material based on nanometric particles of AlOOH functionalised with TFP and dispersed in the PVdF/HFP polymer covers the substrate.

Optical properties of the organic-inorganic hybrid coating prepared in accordance with the present example:
FIG. 5 gives the value of the transmission (%) as a function of the wavelength (A) for a substrate coated with a material according to the invention, prepared in accordance with the present example, which is a hybrid material comprising TFP-functionalised AlOOH nanoparticles and a PVdF/HFP copolymer at various percentages by weight (10%, 20%, 30% and 40%); for an uncoated substrate (naked substrate); and for a substrate coated with a thin layer of TFP-functionalised AlOOH;
the invention makes it possible, as shown by FIG. 5, to obtain a thin organic-inorganic hybrid layer without optical loss by absorption and/or scattering, in a wide range of wavelengths.

For these thin layers, the thicknesses (e_{c}=210 nm) and the refractive indices (n_{c}=1.41 at 1200 nm) are identical irrespective of the fraction by mass of polymer incorporated.

### Example 2

In this example, a thin layer of organic-inorganic hybrid material comprising colloidal nanoparticles of zirconium oxide functionalised with 3,3,3-trifluoropropyltrimethoxysilane (TFP) is prepared.

In a first step, a colloidal suspension (1) of zirconium oxide nanoparticles is prepared.

The protocol used for synthesizing ZrO₂ nanoparticles is described in reference [17] and the molar proportions used are the following:

n_{H}_{₂}_{O}/n_{ZrOCl}_{₂}/nᵤᵣₑₐ=100/1.2/1.4.

The particles synthesized in water are dispersed in methanol by dialysis, until a completely methanolic sol containing 5% by mass of oxide is obtained. The molecular compound (3), the 3,3,3-trifluoropropyltrimethoxysilane (TFP), is then added to the solution (1). The organosilane/oxide molar ratio can be between 0.05 and 5 and more specifically between 0.1 and 0.5, for example 0.3.

The transmission electron microscopy photographs of the ZrO₂ before grafting of TFP and of the ZrO₂-TFP hybrid are represented in FIGS. 6 and 7. The excess TFP acts as a binder and it can be considered that the ZrO₂-TFP plays the role of an inorganic polymer.

The functionalisation of the nanoparticles makes it possible to limit the aggregation that can be seen on the photograph of FIG. 6. This functionalisation thus makes it possible to obtain nanoparticles that can be dispersed in various types of organic solvent.

### Example 3

In this example, a reflective coating composed of a stack of layers with a high and with a low refractive index is prepared.

The layer with a low refractive index is based on colloidal silica and the layer with a high refractive index is based on the hybrid material prepared in Example 2.

The colloidal silica is synthesized on the basis of the protocol described in reference [18], in order to obtain a solution at 1% by mass in ethanol.

The organic-inorganic hybrid material is synthesized as described above in Example 2, with zirconium oxide ZrO₂ and trifluoropropyltrimethoxysilane (TFP), so as to obtain a hybrid solution at 2% by mass in methanol.

The refractive index of the hybrid layer was optimised by adding an amount n_{TFP}/n_{ZrO}_{₂}=0.3, so as to obtain a layer with a refractive index n_{c}=1.70.

A coating exhibiting 90% reflection at λ=600 nm was obtained by spin-coating using the following stack: substrate/[SiO₂/ZrO₂-TFP]⁶ (6 pairs of SiO₂/ZrO₂₋TFP layers that are stacked).

In order to produce this stacking, the layer of colloidal silica is obtained by spin-coating at the speed of 500 rpm. That of the hybrid material is obtained in two passes at the speed of 450 rpm. A heat treatment for 15 minutes at 120° C. was carried out between each layer with a low and with a high refractive index. The UV/visible spectrum of this stack is represented in FIG. 8.

As can be seen in FIG. 8, the experimental stack spectrum, which exhibits a reflection of 90% with 6 pairs of layers with a low and high refractive index, is in accordance with that obtained by means of the simulation. However, it can be noted that, at the low wavelengths, the percentage transmission drops, reflecting the presence of slight scattering.

FIG. 9 shows a photograph of a coating which is homogeneous over the entire substrate and is prepared using the process described. The preparation of such a reflecting stack shows that the nature of the organic-inorganic hybrid layer with a high refractive index is of very good optical quality.

The examples above show that the process for manufacturing the organic-inorganic hybrid material is possible using oxides of different natures. These materials then make it possible to prepare transparent coatings with a suitable refractive index, for being part, for example, of the composition of reflective coatings.

### LITERATURE REFERENCES

[1] H. Floch and P. Belleville “Composite material with a high refractive index, process for producing said composite material and optically active material incorporating said composite material”. U.S. Pat. No. 5,858,526, (1999).
[2] J. Baran, B. Gabrio, J. Stefely, S. Stem and T. Wood. “Stabilized particle dispersions containing surface-modified inorganic nanoparticles”. Application WO-A2-2004/108116, (2004).
[3] N. Cioffi, L. Torsi, N. Ditaranto, G. Tantillo, L. Ghibelli, L. Sabbatini, T. Bleve-Zacheo, M. D'alessio, P. G. Zambonin and E. Travera, “Copper nanoparticle/polymer composites with antifungal and bacteriostatic properties”. Chemistry of materials. 17, (2005), p. 5255-5262.
[4] K. Akamatsu, N. Tsuboi, Y. Hatakenaka and S. Deki, “In situ spectroscopic and microscopic study on dispersion of Ag nanoparticles in polymer thin films”. Journal of physical chemistry B. 104, (2000), p. 10168-10173.
[5] I. Denisyuk and T. Williams. “Polymer nanocomposite having surface modified nanoparticles and methods of preparing same”. Patent application WO-A1-2006/104689, (2006).
[6] J. Baran and W. Hunt. “Solution containing surface-modified nanoparticles”. Patent application WO-A1-2005/056698, (2005).
[7] R. Nonninger and O. Binkle. “Colloidal system of ceramic nanoparticles”. Patent application US-A1-2005-0250859, (2005).
[8] J. Baran, M. Johnson and J. Laperre. “Polymer blends including surface-modified nanoparticles and methods of making the same”. Patent application WO-A1-2006/083431, (2006).
[9] B. Y. Wei, S. L. Ho, F. Y. Chen and H. M. Lin, “Optimization of process parameters for preparing WO₃/polyacrylonitrile nanocomposites and the associated dispersion mechanism”. Surface and coatings technology. 166, (2003), p. 1-9.
[10] U.S. Pat. No. 5,134,021
[11] FR-A-2 681 534
[12] U.S. Pat. No. 4,478,909
[13] U.S. Pat. No. 4,170,690
[14] FR-A-2 882 746
[15] FR-A-2 680 583
[16] B. E. Yoldas, “Alumina Sol preparation from alkoxides”. Ceramic Bulletin. 54, 3, (1975), p. 289-290.
[17] S. Somiya and M. Yoshimura, “Hydrothermal processing of ultrafine single-crystal zirconia and hafnia powders with homogeneous dopants”, Advances in ceramics. 21, (1987), p. 43-55.
[18] W. Stober, “Controlled growth of monodisperse silica spheres in the micron size range”. Journal of colloid and interface science. 26, (1968), p. 62.

1-16. (canceled)

17. A process for preparing a solution containing an organic-inorganic composite material in an apolar, aprotic solvent, in which the following successive steps are carried out:
preparing a first suspension of colloidal particles of at least one inorganic compound selected from metal oxides and oxyhydroxides or metalloid oxides and oxyhydroxides by a hydrolysis-condensation process, in a protic or polar solvent;
mixing the first suspension with an organic compound capable of surface-functionalising the particles, so as to obtain a second suspension comprising the colloidal particles and the organic compound in the polar or protic solvent;
grafting the organic compound onto the surface of the colloidal particles, whereby a third suspension of the particles surface-functionalised with the organic compound in the polar or protic solvent is obtained;
exchanging the protic or polar solvent of the third suspensions with an apolar, aprotic organic solvent, so as to obtain a fourth suspension of the particles surface-functionalised with the organic compound in the apolar, aprotic organic solvent;
preparing a polymer solution by dissolving an organic or inorganic polymer in the apolar, aprotic organic solvent;
mixing the fourth suspension and the polymer solution, so as to obtain an organic-inorganic hybrid solution.

18. The process according to claim 17, wherein the hydrolysis-condensation process by which the colloidal particles are prepared is selected from hydrothermal processes and sol-gel processes.

19. The process according to claim 17, in which the colloidal particles have an average size of from 1 to 100 nm.

20. The process according to claim 17, in which the metal oxides or metalloid oxides are selected from oxides of scandium, yttrium, lanthanum, titanium, zirconium, hafnium, thorium, niobium, strontium, tantalum, cerium, antimony, tin, nickel, magnesium, manganese, iron, cobalt, germanium and silicon; mixed oxides thereof; and mixtures of the metal oxide or metalloid oxides and the mixed oxides thereof.

21. The process according to claim 17, in which the metal oxyhydroxides or metalloid oxyhydroxides are chosen from oxyhydroxides of scandium, yttrium, lanthanum, titanium, zirconium, hafnium, thorium, niobium, strontium, tantalum, cerium, antimony, tin, nickel, magnesium, manganese, iron, cobalt, germanium and silicon; mixed oxyhydroxides thereof; and mixtures of the metal oxyhydroxides and metalloid oxyhydroxides and the mixed oxyhydroxides thereof.

22. The process according to claim 17, in which the protic or polar solvent is selected from water; saturated or unsaturated aliphatic alcohols of formula ROH, where R represents an alkyl group having from 1 to 30 carbon atoms or a phenyl group; diols of formula HOR′OH, where R′ represents an alkyl group having from 1 to 30 carbon atoms or a phenyl group; and mixtures thereof.

23. The process according to claim 17, in which the organic compound is an organosilane or a complexing molecular compound.

24. The process according to claim 23, in which the organosilane corresponds to the formula: (R¹)ₓ-SiX₍₄₋ₓ₎, where R¹ is an alkyl group having from 1 to 10 carbon atoms, X is a hydrolysable group, and x is 1, 2 or 3.

25. The process according to claim 24, in which the organosilane corresponds to the formula: R¹Si(OR²)₃, where R¹ and R² independently represent alkyl groups having from 1 to 10 carbon atoms.

26. The process according to claim 23, in which the organosilane is selected from (C1 to C10)alkoxysilanes; tri(C1 to C10)alkoxy(C6 to C10)arylsilanes, isooctyltrimethoxysilane; silanes comprising a (meth)acrylate function; polydi(C1 to C10)alkylsiloxanes; substituted or unsubstituted (C6 to C10)arylsilanes; substituted or unsubstituted (C1 to C10)alkylsilanes; and fluorosilanes.

27. The process according to claim 23, in which the complexing organic compound is selected from carboxylates of formula R³COO⁻ in which R³ is a linear or branched alkyl group having from 1 to 30 carbon atoms or a phenyl group; β-diketonates and β-diketonate derivatives; phosphonates; hydroxamates of formula R¹²CO(NHOH) in which R¹² is a linear or branched alkyl group having from 1 to 30 carbon atoms or a phenyl group; diolate groups of formula —OR¹³—OH where R¹³ is a linear or branched alkyl group having from 1 to 30 carbon atoms, or a phenyl group.

28. The process according to claim 17, in which the grafting of the organic compound onto the surface of the colloidal particles is carried out by means of a heat treatment.

29. The process according to claim 17, in which the apolar, aprotic organic solvent is selected from ketones; tetrahydrofuran; 1,4-dioxane, toluene; styrene; cyclohexane; acetronitrile; amides; fluorinated solvents; ethers; esters and mixtures thereof.

30. The process according to claim 17, in which the exchanging of the polar or protic solvent of the third suspension with the apolar, aprotic organic solvent is carried out by azeotropic distillation or by dialysis of the third suspension against the apolar, aprotic organic solvent.

31. The process according to claim 17, in which the organic compound is added in a proportion of from 1% to 99% by mass relative to the mass of the inorganic compound selected from metal oxides and oxyhydroxides or metalloid oxides and oxyhydroxides.

32. The process according to claim 17, in which the organic polymer is selected from polymers that are soluble in apolar, aprotic solvents.

33. The process according to claim 17, in which the organic polymer is selected from polyvinyl polymers; polysiloxanes; polymethacrylates; polyacrylates; polyesters; polyether-esters; polyurethanes; fluorinated polymers and copolymers; polystyrenes; polycarbonates; polysilazanes; polyvinylcarbazoles; polyphosphazenes; and blends thereof.

34. The process according to claim 17, in which the organic polymer/inorganic compound ratio by mass is between 1% and 99%.

35. The process according to claim 17 further comprising the step of depositing the organic-inorganic hybrid solution onto a substrate and evaporating the aprotic, apolar solvent.

36-46. (canceled)

47. The process according to claim 17, wherein the organic compound capable of surface-functionalising the particles is dispersed in the protic or polar solvent.

48. The process according to claim 24, wherein the hydrolysable group is a halide, an acetonate, a carbonate, a sulphate, an acrylate or an alkoxide of formula —OR² where R² is an alkyl group having from 1 to 10 carbon atoms.

49. The process according to claim 28, wherein the heat treatment is carried out by heating the second suspension to a reflux temperature of the polar or protic solvent.

50. The process according to claim 31, wherein the organic compound is added in a proportion of from 5% to 50% by mass, relative to the mass of the inorganic compound selected from metal oxides and oxyhydroxides or metalloid oxides and oxyhydroxides.

51. The process according to claim 33, wherein the polyvinyl polymer is selected from the group consisting of polyvinyl alcohol, polyvinylpyrrolidone, and polyvinylbutyral.

52. The process according to claim 34, wherein the organic polymer/inorganic compound ratio by mass is between 5% and 50%.
